(19) United States
(12) Patent Application Publication
(10) Pub. No.: US 2008/0283429 A1
(43) Pub. Date: Nov. 20, 2008

(54) Portable surfboard-anchor system

(76) Inventor: Michael R. Lockhart, San Clemente, CA (US)

Correspondence Address: PETER J. VAN BERGEN, 402 WEST DUKE OF GLOUCESTER STREET, WILLIAMSBURG, VA, 23185, US

(21) Appl. No.: 11/803,896

(22) Filed: May 16, 2007

(51) Int. Cl. B60R 9/08

(52) U.S. Cl. 206/335

(57) ABSTRACT

A portable anchor for a surfboard is made from a flexible-material shell that defines a wedge shape when it is at least partially filled with a particlized material. An open-ended pocket is formed on a face of the shell such that the pocket can receive the nose of a surfboard therein.

### FIELD OF THE INVENTION

The invention relates generally to accessories used in the transportation of surfboards, and more particularly to a portable, surfboard-anchor system for use in transporting a surfboard in a pick-up truck.

### BACKGROUND OF THE INVENTION

Transporting surfboards to and from the beach using a pick-up truck generally involves using the truck's open bed area to hold the board. To keep a surfboard from getting bounced around and damaged, surfers typically use whatever is readily available (e.g., towels, spare tire, carpet, clothing, etc.) to form a cushion around the surfboard. Unfortunately, more often than not, makeshift cushion arrangements do not adequately secure the surfboard once the truck begins to move. This is especially true of long boards as their length is greater than that of a typical pick-up truck bed. Thus, long boards stick out beyond the end of a pick-up truck's bed and are, therefore, subject to damage as they slide along the top of the truck's liftgate.

### SUMMARY OF THE INVENTION

Accordingly, it is an object of the present invention to provide a system that improves the transportability of a surfboard using a vehicle such as a pick-up truck.

Other objects and advantages of the present invention will become more obvious hereinafter in the specification and drawings.

In accordance with the present invention, a portable anchor for a surfboard is made from a flexible-material shell that defines a wedge shape. An open-ended pocket is formed on a face of the shell such that the pocket can receive the nose of a surfboard therein. When the shell is at least partially filled with a particlized material (e.g., sand), the shell maintains its wedge shape.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a side view that is partially cut away of a portable, surfboard-anchor system in accordance with an embodiment of the present invention;

FIG. 2 is a head on view of the portable surfboard-anchor system taken along line 2-2 in FIG. 1;

FIG. 3 is a top view of the portable surfboard-anchor system taken along line 3-3 in FIG. 1;

FIG. 4 is a side cross-sectional view of the portable surfboard-anchor system positioned in a pick-up truck bed with the nose of a surfboard inserted in the anchor system; and

FIG. 5 is a sectional view of the portable surfboard-anchor system and surfboard nose taken along line 5-5 in FIG. 4.

### DETAILED DESCRIPTION OF THE INVENTION

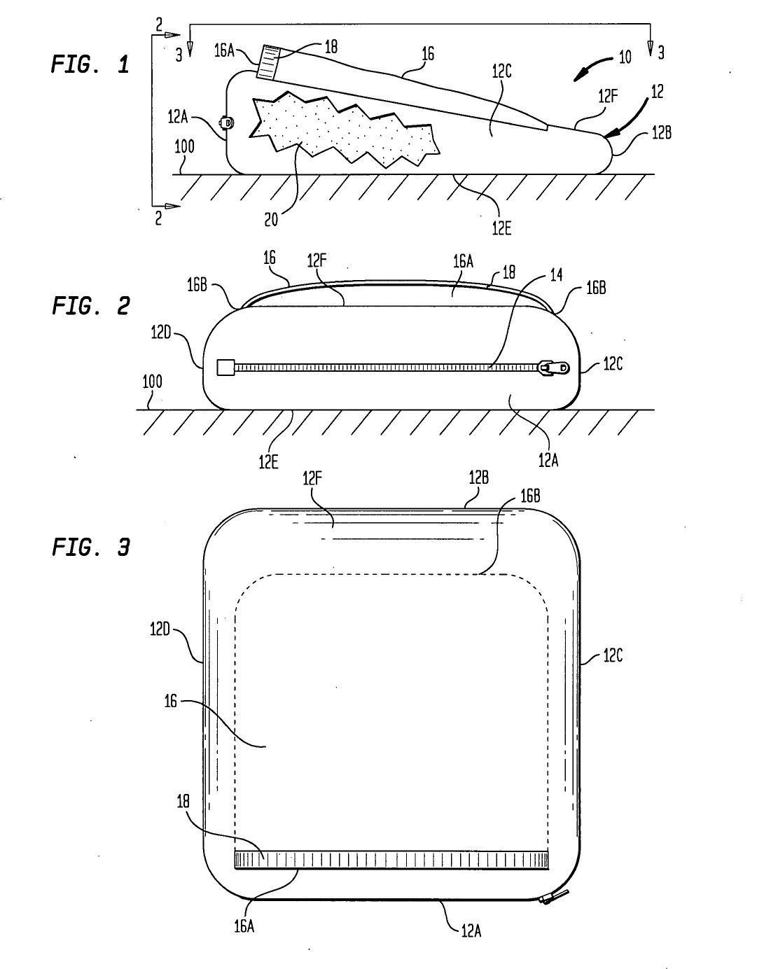

Referring now to the drawings, simultaneous reference will be made to the various views shown in FIGS. 1-3 where a portable, surfboard-anchor system in accordance with an embodiment of the present invention is shown and is referenced generally by numeral 10. As will be explained further herein, portable surfboard-anchor system 10 can be used to anchor any short or “long board” surfboard.

Portable surfboard-anchor system 10 has an outer shell 12 that is made from a flexible material capable of holding a granular or other particlized material 20 therein. Suitable materials for shell 12 include, but are not limited to, fabrics such as any of a variety of polyester-based fabrics, nylon, flexible composites, flexible plastics, etc. To facilitate the filling or emptying of shell 12 with granular material 20, a resealable closure 14 is provided in a vertical face 12A of shell 12. Closure 14 could be realized by a zipper (as shown), but the present invention is not limited to the use of a zipper as any resealable type of closure could be used. Furthermore, the placement of resealable closure 14 is not limited to its illustrated placement in face 12A. That is, resealable closure 14 could be positioned in other areas of shell 12 without departing from the scope of the present invention.

For reasons that will be explained further below, shell 12 defines a substantial wedge-shape (FIG. 1) when substantially or completely filled with granular material 20. That is, when system 10 is resting on a surface 100, four vertical sides of shell 12 include (zippered) face 12A, a face 12B that opposes and is shorter than face 12A, and opposing mirror-image wedge-shaped side faces 12C and 12D. Shell 12 further has a bottom face 12E that rests on surface 100 and a top face 12F that slopes down from the top of face 12A to the top of face 12B. Bottom face 12E and top face 12F can be generally rectangular as shown.

Granular material 20 is any particlized or granular-like material that (i) will provide sufficient weight such that system 10 achieves its anchor function, (ii) has a particle or granular size that will allow it to be contained by shell 12, and (iii) in combination with flexible shell 12 can be easily shaped. In terms of availability, cost, and ease of use, granular material 20 is typically wet or dry sand such as beach sand.

Attached to shell 12 is a flexible material pocket 16 having an open end 16A formed along top face 12F and opening in the direction of taller vertical face 12A. More specifically, pocket 16 is attached to shell 12 along most or all of three edges thereof referred to by dashed line 16B so that an open end 16A is formed over top face 12F and facing vertical face 12A. Attached edge 16B can be stitched or otherwise attached/adhered to top face 12F. Attached edge 16B can define a rounded or beveled perimeter (as shown) to somewhat resemble the nose shape of a surfboard (not shown in FIGS. 1-3) that system 10 will be used to anchor.

The flexible material used for pocket 16 can be the same or different than that used for shell 12. The material could be a conventional woven or non-woven fabric, or could be an open mesh without departing from the scope of the present invention. Still further, the material used for pocket 16 could be inherently elastic so that open end 16A is elastically expandable and collapsible. Additionally or alternatively, a piece of elastic material 18 can be provided along open end 16A with the ends thereof being attached to shell 12 at edge 16B.

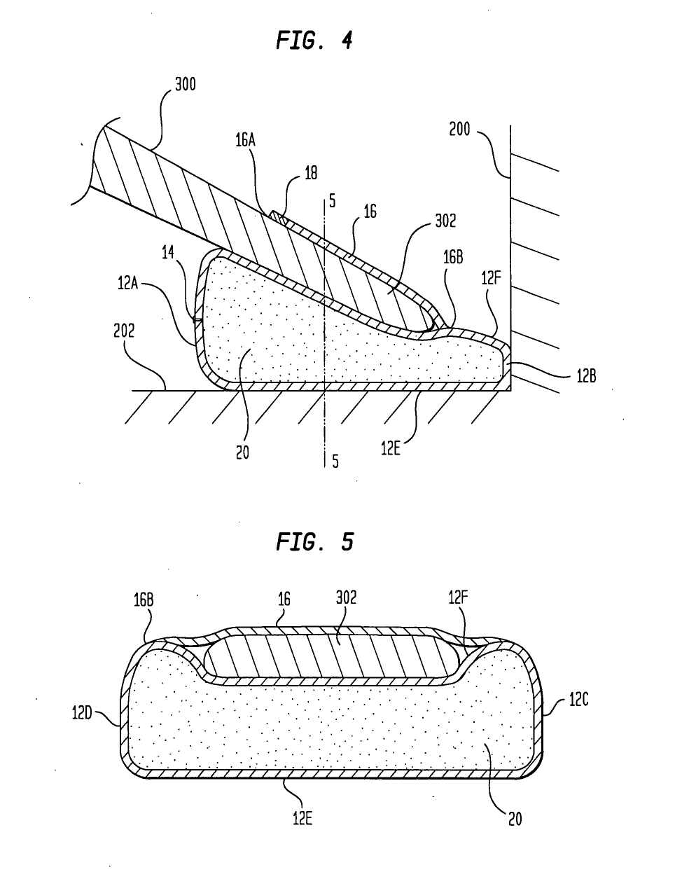

To use system 10, shell 12 is substantially or completely filled with granular material 20 to thereby expand shell 12 into its wedge shape. System 10 is then positioned on a surface. For example, as illustrated in FIG. 4, the front wall and floor of a pick-up truck bed are illustrated and referred to by numerals 200 and 202, respectively, with system 10 being positioned such that bottom face 12E is on floor 202 and face 12B abuts-front wall 200. To anchor a surfboard 300, the nose 302 thereof is placed in pocket 16. The shape of nose 302 and the weight of surfboard 300 cause nose 302 to burrow into the conformable granular material-filled shell 12 as nose 302 is inserted into pocket 16. Pocket 16 holds nose 302 down while shell 12/granular material 20 in their conformed configuration support and hold nose 302 in a side-to-side fashion as illustrated in FIG. 5. The wedge shape of system 10 supports surfboard 300 at an upward angle since the rear end of surfboard 300 will typically rest on top of the pick-up truck's liftgate (not shown).

The advantages of the present invention are numerous. The portable surfboard-anchor system can be used in a vehicle to secure the nose of a surfboard in a cushioned manner. The system is simple to use and the shell is readily folded/packed when the granular material contained therein is emptied. The anchoring and cushioning aspects can be provided by the free and readily-available beach sand.

Although the invention has been described relative to a specific embodiment thereof, there are numerous variations and modifications that will be readily apparent to those skilled in the art in light of the above teachings. For example, the shell of the surfboard-anchor system could be filled with a particlized or granular material at the time of manufacture thereby eliminating the need for resealable closure 14. It is therefore to be understood that, within the scope of the appended claims, the invention may be practiced other than as specifically described.

What is claimed as new and desired to be secured by Letters Patent of the United States is:

1. A portable anchor for a surfboard, comprising:
a flexible-material shell defining a wedge shape with an open-ended pocket being formed on a face of said shell; and
a particlized material filling at least a portion of said shell.

2. A portable anchor as in claim 1 wherein an open-end of said open-ended pocket is elasticized.

3. A portable anchor as in claim 1 further comprising a resealable closure formed in said shell.

4. A portable anchor as in claim 3 wherein said resealable closure comprises a zipper coupled to said shell.

5. A portable anchor as in claim 1 wherein said particlized material is sand.

6. A portable anchor for a surfboard, comprising a flexible-material shell defining a wedge shape with an open-ended pocket being formed on a face of said shell that is adapted to receive the nose of a surfboard therein, said shell further being adapted to be at least partially filled with a particlized material to thereby cause said shell to maintain said wedge shape.

7. A portable anchor as in claim 6 wherein an open-end of said open-ended pocket through which the nose is received is elasticized.

8. A portable anchor as in claim 6 further comprising a resealable closure formed in said shell, said resealable closure being adapted to support passage of the particlized material therethrough.

9. A portable anchor as in claim 8 wherein said resealable closure comprises a zipper coupled to said shell.

10. A portable anchor as in claim 1 wherein the particlized material is sand.

11. A portable anchor for a surfboard, comprising:
a flexible-material shell having a bottom, a top, and four sides connecting said bottom to said top, said four sides including (i) first and second wedge-shaped sides opposing one another in a mirror-image fashion, and (ii) third and fourth sides coupled between said first and second wedge-shaped sides wherein said third side is larger than said fourth side;
a flexible-material pocket coupled to said top, said pocket having an open end substantially facing towards said third side of said shell; and
a resealable closure formed in said shell and adapted to received therethrough a particlized material wherein, when said shell is at least partially filled with the particlized material, said shell maintains a wedge shape.

12. A portable anchor as in claim 11 wherein each of said bottom and said top are generally rectangular in shape.

13. A portable anchor as in claim 11 wherein said resealable closure is in said third side.

14. A portable anchor as in claim 11 wherein said open end of said pocket is elasticized.

15. A portable anchor as in claim 11 wherein said resealable closure comprises a zipper.

16. A portable anchor as in claim 11 wherein the particlized material is sand.
